(19) United States
(12) Patent Application Publication
(10) Pub. No.: US 2020/0093327 A1
(43) Pub. Date: Mar. 26, 2020

(54) AUTOMATIC COOKING APPARATUS AND METHOD OF USING IT FOR COOKING

(71) Applicant: SHANGHAI CHANGSHAN INTELLIGENT TECHNOLOGY CORPORATION LIMITED, Shanghai (CN)

(72) Inventor: Xinlei HUA, Shanghai (CN)

(21) Appl. No.: 16/484,474

(22) PCT Filed: Jan. 22, 2018
(86) PCT No.: PCT/CN2018/073608

§ 371 Date: Aug. 8, 2019

(30) Foreign Application Priority Data
Jan. 23, 2017 (CN) 201710050533.4

(51) Int. Cl. A47J 36/32; A23L 5/10; G05B 19/042

(52) U.S. Cl. CPC A47J 36/321; A23L 5/10; G05B 2219/2643; A23V 2002/00; G05B 19/042

(57) ABSTRACT

An automatic cooking apparatus (100), the automatic cooking apparatus (100) comprises at least one holding device (101) configured to receive and store unit material, wherein the unit material have corresponding material information; at least one cooking device (102) configured to receive and process unit material from the at least one holding device (101); a material transfer device (103) configured to transfer the unit material between the at least one holding device (101) and the at least one cooking device (102); a control device (104) configured to acquire material information of the unit material stored in the at least one holding device (101) to control the material transfer device (103) to transfer the unit material between the at least one holding device (101) and the at least one cooking device (102), and control the at least one cooking device (102) to process the received unit material.

### CROSS REFERENCE TO RELATED APPLICATIONS

The present application claims priority to Chinese Patent Application No. 201710050533.4 filed on Jan. 23, 2017, the content of which is incorporated herein in its entirety by reference.

### TECHNICAL FIELD

The present application relates to an automatic cooking apparatus, and more particularly, to a standardized automatic cooking apparatus and a method of using it for cooking.

### BACKGROUND

With the accelerating pace of life in modern society there is an increasing demand for fast, delicious food with consistent quality. Due to the complexity of Chinese cooking process, in particular, the drastic change during the short period of cooking time of stir-frying when high heat made the chemical change to both the food ingredients and seasoning agents, all having an impact on the color, flavor and the looks of final dishes, the work has been an art, requiring years of practice to produce decent dishes. Take as an example, the cooking of Sushijin (mixed vegetables) which involves cooking of bamboo shoots, shiitake mushrooms, fresh mushrooms, wood ear, water chestnuts, water gluten, yuba, fried-gluten, daylily and the like, because of their different material properties, each material needs to be processed separately. Manual operation on these materials is a time-consuming process, and the quality is difficult to maintain. Under such circumstances, manual operation is unable to meet the demand.

However, at present, cooking apparatuses on the market basically can only have one or several functions such as deep-frying, stir-frying, boiling and the like. Although these apparatuses can partially replace manual operations and meet the demand of large supply, the simple application and direct combination of the above functions obviously cannot successfully cook distinctive Chinese food. People have also invented automatic cooking apparatuses that use pre-loaded computer programs to operate the cooking process.

However, the above mentioned apparatuses have relatively low levels of automation and intelligence, and may not fully standardize the cooking process. In particular, the materials to be cooked and the various parameters of the seasonings are not standardized, thus the quality of the final dishes are hard to be consistent.

### SUMMARY

An objective of the present application is to provide an automatic cooking apparatus capable of supplying a large quantity of meals in a fast, consistent and efficient manner.

One aspect of the application discloses an automatic cooking apparatus comprising: at least one holding device configured to receive and store unit material, wherein the unit material has corresponding material information; at least one cooking device configured to receive and process unit material from the at least one holding device; a material transfer device configured to transfer the unit material between the at least one holding device and the at least one cooking device; a control device configured to acquire the material information of the unit material stored in the at least one holding device to control the material transfer device to transfer the unit material between the at least one holding device and the at least one cooking device, and control the at least one cooking device to process the received unit material.

Another aspect of the application discloses a method for cooking with an automatic cooking apparatus, comprising: detecting material information of unit material in at least one holding device; controlling material transfer device to transfer the unit material between the at least one holding device and at least one cooking device; and controlling the at least one cooking device to process the received unit material.

The foregoing is a summary of the present application and may be simplified, summarized, or omitted in detail so those skilled in the art will recognize that this section is merely illustrative and is not intended to limit the scope of the application in any way. This summary is neither intended to identify key features or essential features of the claimed subject, nor intended to be used as an aid in determining the scope of the claimed subject matter.

### BRIEF DESCRIPTION OF THE DRAWINGS

The above and other features of this disclosure would be better understood from the following specification and claims, taken in conjunction with the accompanying drawings. It should be understood that these drawings depict only several embodiments of the disclosure and therefore should not be considered as limiting the scope of the disclosure. By applying the drawings, the present application will be described more clearly and in better details.

FIG. 1 illustrates a schematic view of an automatic cooking apparatus according to an embodiment of the present application;

FIG. 2 illustrates a schematic view of the internal structure of a storage device in the automatic cooking apparatus shown in FIG. 1 of the present application;

FIG. 3 illustrates a schematic view of an automatic cooking apparatus according to another embodiment of the present application;

FIG. 4 illustrates a perspective view of an automatic cooking apparatus according to an embodiment of the application;

FIG. 5 illustrates a perspective view of the material transfer device of the automatic cooking apparatus shown in FIG. 4;

FIG. 6 illustrates a partial perspective view of the automatic cooking apparatus shown in FIG. 4;

FIG. 7 illustrates a partial perspective view of the automatic cooking apparatus shown in FIG. 4;

FIG. 8 illustrates a flowchart of a cooking method using an automatic cooking apparatus according to an embodiment of the present application.

### DETAILED DESCRIPTION

In the following descriptions, reference is made to the drawings that form a part hereof. In the drawings, similar symbols generally identify similar components, unless context dictates otherwise. The illustrative embodiments described in the detailed description, drawings, and claims are not meant to be limiting. Other embodiments may be utilized and other changes may be made without departing from the spirit or scope of the subject of this application. It is understood that different configurations of arrangements, alternatives, combinations, designs, etc., may be made to the various aspects of the present disclosure, which are described in general terms and illustrated via the figures, and all of which constitute explicitly part of the current application.

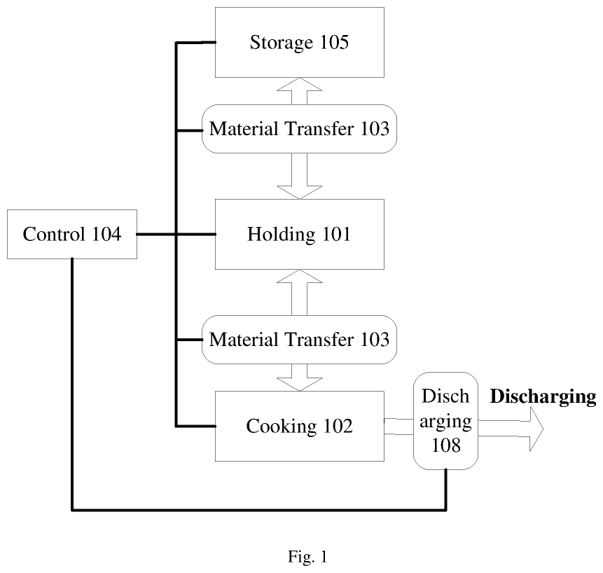

FIG. 1 illustrates a schematic view of an automatic cooking apparatus 100 according to one embodiment of the present application.

As is shown in FIG. 1, the automatic cooking apparatus 100 includes a holding device 101, a cooking device 102, a material transfer device 103, and a control device 104. The holding device 101 is configured to receive and store unit materials with corresponding material information. The unit materials and their corresponding material information will be described in detail below. The material transfer device 103 is used to transfer the unit material between the holding device 101 and the cooking device 102. The cooking device 102 receives the unit materials and executes the cooking process to finally obtain a dish. The control device 104 has communication channels connected with the holding device 101, the cooking device 102, and the material transfer device 103. The control device 104 can acquire the material information of the unit material stored in the holding device 101 so as to control the material transfer device 103 to transfer the unit materials between the holding device 101 and the cooking device 102, and to control the cooking device 102 to process the received unit material. In some embodiments, the control device 104 may further acquire a cooking program and execute the obtained cooking program to control the material transfer device 103 to transfer the unit material between the at least one holding device 101 and the at least one cooking device 102, and to control the cooking device 102 to process received unit material to get the dish.

In some embodiments, the cooking program refers to a collection of one or more required parameters to produce the final dish. In some embodiments, the cooking program may include at least one of the following parameters: the type of the unit material, the quantity or weight of the desired unit material, the desired cooking process, and conditions for the cooking process. In some embodiments, the cooking program may further include a pretreatment method of the unit material. It should be understood that the pretreatment method should include all existing pretreatment methods for making the dish, such as thickening (eg. with starchy sauce), marinating, frying and the like. In some embodiments, the cooking program may further include a cooking process of the unit material. Such cooking process may be any or all of the cooking processes required for cooking Chinese and Western dishes and a combination of these specific processes. The cooking processes include but are not limited to: deep-frying, wet-stir-frying, dry-stir-frying, rapid-stir-frying, braising, sauté, frying, pan-frying, roasting, steaming and boiling. In one embodiment, such as a cooking program for a dish of spicy chickens, the cooking program may include frying chicken pieces first and then stir-frying the fried chicken pieces and chili. Of course, conditions for the cooking process may also be included in the cooking program, which may be the sweetness, saltiness, acidity, viscosity or moisture of the unit material or dish during cooking, as well as the air pressure in the cooking device, the cooking temperature and heating method, time and so on.

Table 1 shows a simple example of a cooking program that dictates when to put material in, the quantity of material to put in, as well as the duration and conditions of cooking. As is shown in Table 1, the cooking program is used to cook a dish of chili pork. After the control device 104 reads the cooking program, the automatic cooking apparatus 100 is started, and the cooking device 102 starts to heat. 10 seconds after start-up, the control device 104 controls the delivery of minor food material, that is, delivering 20 grams of oil into the cooking device 102, and controlling the cooking device 102 to continue heating with a certain power. Next, 20 seconds after start-up, 100 grams of sliced pork, labeled unit material No. 001120100, is put into the cooking device 102, while heating is continued. Then, 40 seconds after start-up, 200 grams of pepper, labeled unit material No. 002120200, are put into the cooking device 102. At this point, the cooking device 102 has been heated continuously for about 40 seconds. Then, 80 seconds after set-up, the seasoning materials, such as salt, soy sauce and the like with designated quantities, are put in, then heating stops. 90 seconds after start-up, the dish from the process in cooking device 102 can be discharged.

TABLE 1
chili pork

| | Main material or minor | |
|---|---|---|
| Time | food material | Conditions |
| 10 seconds after | Put in 20 g of oil | Heat to 300 |
| start-up | | degree C. |
| 10 seconds after | Put in 100 g of sliced | Keep heated |
| start-up | pork (unit material No. | between 180 and |
| | 001120100) | 250 degree C. for |
| | | 20 seconds |
| 40 seconds after | Put in 200 g of peppers | Keep heated |
| start-up | (unit material | between 180 and |
| | No. 002120200) | 250 degree C. for |
| | | 40 seconds |
| 80 seconds after | Put in 5 g of salt, 5 g | Stop heating |
| start-up | of soy sauce | |
| 90 seconds after | Discharging | — |
| start-up | | |

In the process of delivering the material, the control device 104 may at the same time monitor the inventory information of the unit material in the holding device 101 and instruct the material transfer device 103 to obtain the unit material from the holding device 101. Table 2 shows an example of storing unit material in the holding device 101. As is shown in Table 2, a holding device 001 stores 8 units of unit material No. 001120100, and a holding device 003 stores 3 units of unit material No. 002120200 and so on. When the cooking program shown in Table 1 is executed, 20 seconds after the start-up, the control device 104 controls the material transfer device 103 to take 1 unit of unit material No. 001120100 and puts it into the cooking device 102. Next, 40 seconds after the start-up, the control device 104 controls the material transfer device 103 to take 1 unit of unit material No. 002120200 from the holding device 001 and put it into the cooking device 102. Correspondingly, the holding device 001 may also update the inventory information of the unit material stored therein in real time, for example, the quantity of unit material in holding device 001 is reduced to 7 units.

TABLE 2
holding device

| holding device | Type of unit | Quantity of unit |
|---|---|---|
| number | material | material |
| holding device | unit material No. 001120100 | 8 |
| No. 001 | | |
| holding device | unit material No. 001130200 | 5 |
| No. 002 | | |
| holding device | unit material No. 002120200 | 3 |
| No. 003 | | |
| holding device | N/A | N/A |
| No. 004 | | |
| holding device | unit material No. 002620200 | 1 |
| No. 005 | | |
| . . . | . . . | . . . |

It can be understood that in some embodiments, the quantity or weight of the unit material stored in the holding device 001 can also be maintained to just meet the needs of the current cooking program. Specifically, in the cooking program described in Table 1, the holding device 001 only stored 1 unit of unit material No. 001120100, and after the material transfer device 103 retrieves the unit material No. 001120100 from the holding device 001 according to the cooking program, the holding device 001 is vacant.

In some embodiments, after the holding device 001 is vacant, the control device 104 may control the material transfer device 103, according to at least one acquired cooking program, to transfer another unit material, 200 grams of peppers (i.e., one unit of unit material No. 002120200) from the storage device 105 (details about the storage device will be described later) to the holding device 001. In other embodiments, after the holding device 001 is vacant, the control device 104 controls the material transfer device 103 to transfer a predetermined quantity of unit material required by the next cooking program to the holding device 001, according to the next acquired cooking program to be executed. Assuming that the cooking program to be executed after executing the cooking program in Table 1 above is scrambled egg with tomato. After the holding device 001 is vacant, the control device 104 controls the material transfer device 103 to transfer 1 unit of unit material No. 016120200 (200 g tomato) required by the next cooking program to be executed from the storage device 105 to the holding device 001. Of course, in some embodiments, the unit material includes cooking minor food material and other material such as oil and water, the control device can also control the corresponding material transfer device to act so as to realize the delivery of the material.

It should be noted that, the cooking programs provided in the above embodiments are merely exemplary, and it can be understood that the cooking program may include all the factors related to cooking dishes.

In some embodiments, the control device 104 may obtain the cooking program according to operator's instructions. It should be noted that the operator's instructions may be a specific dish cooking program or just one or more parameters in the cooking program (e.g., the cooking program is a standardized program with adjustable parameters) and the control device obtains specific cooking program according to the parameters. Taking the cooking program described in the above Table 1 as an example, the operator inputs various parameters of the cooking program listed in Table 1 through an input device (which will be described later). In some embodiments, the automatic cooking apparatus 100 further includes a cooking program database, which includes at least one cooking program. The operator may only input the types of unit material as pork and green peppers or only enter the cooking time as 90 seconds. The control device, in accordance with the parameters entered by the operator as well as the unit material information of the unit material stored in the holding device 101, acquires a cooking program described in Table 1 from the existing cooking database through matching. It should be noted that the control device 104 may have more than one matched cooking program in the cooking program database according to the material information of the unit material stored in the holding device 101 and/or the parameters of the cooking program entered by the operator. The operator may determine which of the above several matching cooking programs is finally executed by the control device 104.

In some embodiments, the control device 104 may automatically acquire the cooking program based on the obtained information about the unit material. Taking the cooking programs described in Tables 1 and 2 above as an example, when the control device 104 acquires the knowledge that the holding device No, 001 stores 1 unit of unit material No. 001120100 (100 g pork), the holding device 002 stores 1 unit of unit material No. 002120200 (200 g peppers), the control device 104 matches that information with the cooking programs in the database and obtains the cooking program listed in Table 1. It should be noted that the unit material information obtained by the control device 104 does not need to be completely consistent with the parameters stored in the cooking program database of the control device 104, and the control device 104 can reasonably adjust the cooking programs according to the similarities so as to obtain the final cooking program. Take the cooking program described in Table 1 as an example, the cooking program database may store the cooking programs listed in Table 1, while the holding device 001 stores 1.5 units of the unit material No. 001120100 (150 g pork) and the holding device No, 002 stores 1.5 units of unit material No. 002120200 (300 g peppers). Under such condition, the control device 104 may proportionally modify the cooking condition parameters, such as the quantity of salt or soy sauce, cooking time and firepower, on the basis of the cooking program listed in Table 1 in its cooking database, and arrived at the optimal cooking program for execution.

It should be noted that, although only one cooking program (such as the cooking program shown in Table 1) is acquired and executed by the control device 104 in the above embodiments, in other embodiments, the control device 104 may also acquire multiple cooking programs and execute multiple acquired cooking programs. In some specific embodiments, the cooking apparatus 100 may be configured to acquire a plurality of cooking programs based on the statistics of the material information of the unit material in the storage device 105 and/or the holding device 101 to provide a complete meal for one or more people.

In some embodiments, the above automatic cooking apparatus further includes a menu database including at least one cooking program. Users may select a dish in the menu database corresponding to a cooking program. In some examples, the cooking program described above may be one or more fixed cooking programs that have been tested in advance and verified to be successful, including recipe information such as the type, weight, shape and size of the desired unit material, as well as process parameters including heating power, heating time, etc. In other embodiments, the cooking program may be determined on spot by calculations from a well-developed model, using data on the weight, shape and size of the unit material, in combination with the specific parameters such as the diffusion coefficients, the temperature, the moisture, and doneness of the unit material. In some embodiments, the above mentioned cooking program model is acquired through learning from the big data of the cooking appliances.

In some embodiments, the holding device 101 may be an open container of circular, square or other regular shapes for easy retrieval of the unit material stored therein. In other embodiments, the holding device 101 may also be a closed container of circular, square or other regular shapes, so as to form a storage space in the interior to satisfy certain conditions (such as temperature) for storing the unit material. In addition, the closed container may have an openable opening to facilitate access to (put in/take out) the unit material. In some embodiments, the holding device 101 may be made of metal, plastic, ceramic material, or a combination thereof, preferably made of a transparent material, so as to allow the user to observe the unit material stored therein. In some embodiments, the holding device may consist of a metal frame embedded removable plastic liner to facilitate grabbing of the transfer device and loading of the unit material. In some specific embodiments, the automatic cooking apparatus 100 may include a plurality of holding devices 101. Different holding device 101 may store different unit material. In some embodiments, different holding devices 101 may have different sizes of storage spaces for storing unit material of different quantities or sizes. Taking the holding device listed in the above Table 2 as an example, the spatial capacity of the holding device 003 may be larger than or equal to the sum of that of the holding devices 001 and 002. Therefore, the holding device 003 may be used for storing both the processed unit material of the holding device 001 and the processed unit material of the holding device 002.

In some embodiments, the holding device 101 also has a stock status detector (not shown) that is configured to detect at least one stock status parameter within the holding device 101. The stock status parameter may reflect the status of the stock. In some embodiments, the stock status parameter can include at least one of the following parameters: temperature, humidity, air pressure, bacteria species, the quantity of bacteria, sulfide concentration, and material appearance. The corresponding stock status detector may be a temperature sensor, a humidity sensor, an air pressure sensor, a microbial sensor, a sulfide sensor, a camera, etc. The storage conditions, as well as the freshness of the stored materials etc. of the holding device 101 can be determined according to the above stock status parameter.

In some embodiments, the holding device 101 further includes a stock status controller (not shown) that is configured to control at least one stock status parameter of the holding device 101 within a predetermined range. For example, in some embodiments, the stock status detector is an image detector with a camera for detecting the shape and appearance of the unit material, and when the appearance of the stored unit material shows deterioration (such as discoloration or having black spots, etc.), The stock status detector may send a warning signal to warn the deterioration of food so as to ensure food safety. Similarly, in some embodiments, the stock status detector is an electronic nose for detecting the quantity of sulfide gas in the holding device, and when the quantity exceeds a predetermined level, prompts that there is a risk of material deterioration, or adjusts the temperature inside the holding device by a temperature controller to extend the material storing time. In some embodiments, the stock status detector may be a humidity sensor and an air pressure sensor, so as to detect the air pressure and humidity in the holding device 101, and the automatic cooking apparatus 100 may also have a humidifier (or dehumidifier), a gas generator, etc., to control the air pressure and/or humidity in the holding device 101 within a specified range and ensure the freshness of unit material and its storage time.

In some embodiments, the stock status detector may be a temperature sensor and the corresponding stock status controller may be a temperature controller, i.e., a heating or cooling device (e.g., a semiconductor refrigerator) that is used to heat or cool the holding device 101 to control the temperature in the holding device 101 so as to realize the pre-treatment of the unit material stored therein, such as heat preservation, refrigeration or thawing. In some embodiments, the temperature controller may be a semiconductor temperature controller or a magnetic induction heater. In addition, by controlling rate or time of the heating or cooling of the holding device 101, the temperature controller can tailored the time required for the thawing process according to the stored unit material and the cooking program.

Specifically in some embodiments, the temperature sensor and the temperature controller of the holding device 101 control the temperature and the rate of heating or cooling of the holding device 101 according to the specific material information of the unit material, so as to optimize the warm keeping, refrigeration and thawing effort for different unit materials. For example, the best fresh-keeping temperature for short-term cold-storage meat is usually 0° C. to 1° C. In a particular embodiment, the unit material stored in the holding device 101 is pork, the temperature sensor and temperature controller of the holding device 101 will control the temperature in the holding device 101 to 0° C., so as to ensure the stored pork is fresh and safe. As another example, for different meat, the freezing methods are different, and the thawing methods are also different. If the freezing and thawing methods are incorrect, they will easily lead to the loss of food nutrition, and even speed up the deterioration of meat. In some specific embodiments, the unit material stored in the holding device 101 is frozen fish and needs to be thawed. The temperature sensor and temperature controller of the holding device 101 first control the temperature in the holding device to minus 5 degree C., and then after a period of time, control the temperature to zero degree C., so as to achieve phased thawing of the frozen fish, thereby avoiding the loss of nutrition.

In some embodiments, the temperature sensor and the temperature controller of the holding device 101 control the temperature and rate of heating or cooling of the holding device 101, based on the information of the unit material in the holding device 101, in conjunction with various parameters in the cooking program, e.g., the moments that unit materials are transferred into the cooking device 102 for cooking, order by which the unit materials are transferred into cooking device 102, etc. In still another embodiment, when the transfer time of the unit material of the holding device 101 set in the cooking program is delayed, the temperature sensor and the temperature controller of the holding device 101 control the temperature in the holding device 101 to be correspondingly lower so that the unit material can be stored for a longer period of time, so as to keep the material fresh, avoid the spoiling of the unit material and ensure the safety of the material and the quality of dishes. In another specific embodiment, the unit material is in a frozen state and the scheduled cook time in the cooking program is 30 minutes later, then the temperature sensor and temperature controller of the holding device operate at a specified temperature and heating rate to heat and thaw the unit material in the holding device 101 so that the frozen material is just thawed at the scheduled cook time, thus ensuring the freshness of the various unit materials during the cooking process.

Similarly, the order of the cooking processes will also dictate the temperature control of the holding device 101 by the temperature sensor and the temperature controller. In still another specific embodiment, what stored in the holding device 101 is an intermediate material after an intermediate process of the cooking program executed by the control device 104. The intermediate processes includes, but is not limited to, deep-frying, wet-stir-frying, dry-stir-frying, rapid-stir-frying, braising, sauté, frying, pan-frying, roasting, steaming and boiling, etc. According to the cooking program, such intermediated material needs to wait for the unit material in another holding device to be processed before its own turn. To preserve the temperature of such intermediate material in the holding device 101 and thus ensuring the taste of the final processed dish, the temperature sensor and the temperature controller of the holding device 101 need provide the required heating. It should be noted that the parameters in the above cooking program can be set either as standardized parameters or as customized parameters according to the needs of users. The temperature sensor and the temperature controller of the holding device 101 may adjust the temperature control in the holding device 101 according to specific parameters to ensure the quality of the standardized dish, while achieving the user customization.

In some embodiments, the cooking device 102 has an inner cavity for accommodating the unit material and a heating device for heating the unit material in the inner cavity to get a dish. The inner cavity can be hemispherical, spherical, cylindrical and in other uniform shapes, thus ensuring that the unit material can be evenly heated during cooking process. The inner cavity of the cooking device 102 may have a capacity of 1.5 L to 20 L, preferably 5 L, 10 L. In some embodiments, the cooking device 102 may have at least one opening for receiving unit material to be processed and/or discharging the processed unit material or dish. The opening has a size of 10 cm to 2 m, preferably 30 to 150 cm. The inner cavity may be made of iron, carbon steel, stainless steel, aluminum alloy, ceramic, or multi-ply sheet consisting of fore-mentioned materials. The inner wall of the inner cavity can have a non-stick surface. The non-stick surface may be achieved by surface ceramic or titanium alloy or plating aluminum anodization.

In some embodiments, the heating device of the cooking device 102 may be any of various commonly used heating devices such as an electromagnetic induction heating device, a microwave heating device, and an open flame heating device. The cooking device 102 may implement one or more of the following processes: deep-frying, wet-stir-frying, dry-stir-frying, rapid-stir-frying, braising, sauté, frying, pan-frying, roasting, steaming and boiling, etc. In some embodiments, the automatic cooking apparatus of the present invention includes a plurality of cooking devices 102, and each cooking device may separately process one or more of the above processes. In particular, in one embodiments, the cooking device may include an electric fryer, a machine for wet-stir-frying, an oven, a frying pan, a steam oven, a pressure cooker and so on. The heating power of the heating device of the cooking device 102 is related to the capacity, size of the inner cavity of the cooking device 102 and the cooking process it implements. Specifically in one embodiment, the heating device of the cooking device 102 capable of implementing the barbecue process is a high-power heating device, specifically a 7.2 KW radiant heating tube.

In some embodiments, the cooking device 102 further includes a stir-frying device (not shown), which may be a stirring device in the inner cavity of the cooking device 102, such as a mechanical stirring device (e.g., having a plurality of blades) or the like, and may also be a rotating device that drives the inner cavity of the cooking device 102 to rotate. The inner cavity of the cooking device 102 is placed on the rotating device and may rotate with the rotating device. It is understood that in addition to rotating the inner cavity of the cooking device, the rotating device may also evolve into a mechanical device that drives the inner cavity to roll, shake or swing. In some embodiments, the stir-frying mechanism of the cooking device 102 may be a combination of the above two methods, namely, stirring the unit material in the inner cavity and driving the inner cavity itself to shake, rotate or swing. In some embodiments, the stir-frying mechanism is a robotic hand that mimics a human hand. The top of the robotic hand is detachably equipped with kitchen utensils, such as spatula, soup spoon, colander and so on, to optimally reproduce the processing details of the dish production, improving the quality of the final dish.

In some embodiments, the material transfer device 103 transfers the unit material between the holding device 101 and the cooking device 102 with a robotic arm and a gripper. This robotic arm and gripper structure is particularly suitable for transferring solid unit material, such as vegetables, meat, rice or the like. In other embodiments, the material transfer device 103 is a differential pressure transfer device that utilizes the pressure difference between the starting point and the destination to achieve the transferring of unit material between the holding device 101 and the cooking device 102, and the differential pressure may be created from sealed pipes. Such differential pressure transfer device is particularly suitable for transfer ting liquid material such as water, oil, soup and the like.

The automatic cooking device 100 may include one holding device, and/or one cooking device. In some embodiments, the automatic cooking device 100 may also include multiple holding devices and one cooking device because the material usually needs to be stored separately. In some embodiments, the automatic cooking device 100 may also include a plurality of holding devices and a plurality of cooking devices, for example include a first holding device and a second holding device, and a first cooking device and a second cooking device. Accordingly, the material transfer device 103 may transfer the unit material between the first holding device or the second holding device and the first cooking device or the second cooking device. The material transfer device 103 may transfer the unit material stored in the first holding device or the second holding device to the first cooking device or the second cooking device for processing under the control of the control device 104. At the same time, it may also transfer the intermediate material processed in the first cooking device or the second cooking device to the first holding device or the second holding device for temporary storage.

The combination of the above material transfer modes enables the cooking apparatus 100 to complete a complicated cooking process. For example, the cooking dish is Kung Pao chicken. The first holding device stores unit quantity and weight of diced chicken, the second holding device stores unit quantity and weight of green garlic, the first cooking device is a frying machine, the second cooking device is a wok. The control device 104 first controls the material transfer device 103 to transfer the diced chicken in the first holding device to the first cooking device for frying and then transfer fried chicken to the first holding device for temporarily storage. Then the green garlic in the second holding device are transferred to the second cooking device by the material transfer device 103 for stir-frying, and then after the green garlic is stir-fried for a period of time par the cooking program, the material transfer device 103 is controlled to transfer the just fried diced chicken, temporarily stored in the first holding device, to the second cooking device to stir-fry with the garlic. Finally, the dish Kung Pao chicken is obtained.

In some embodiments, the material transfer device may also transfer the unit material or the processed intermediate material between the first cooking device and the second cooking device, under the control of the control device 104. The material transfer device 103 may further transfer the processed intermediate material in the first cooking device to the second cooking device for processing. Taking the above Kung Pao chicken as an example, the process of frying the diced chicken in the first cooking device and the process of frying the green garlic in the second cooking device may be performed simultaneously, and then the control device 104 controls the material transfer device to directly transfer the fried diced chicken in the first cooking device to the second cooking device. The fried diced chicken is stir-fried with the green garlic in the second cooking device, and is finally processed into the dish Kung Pao chicken. It should be noted that although the numbers of the holding devices and the cooking devices are two in the above embodiment, the automatic cooking apparatus 100 may include three, four, five, six, and more holding devices and cooking devices. The material transfer device 103 may cross transfer the unit material or processed intermediate material among the plurality of holding devices and cooking devices, thus completing the processing of complex dish.

In some embodiments, the control device 104 may be a PLC controller or a single chip microcomputer controller. In some embodiments, the control device 104 is communicatively connected to the holding device 101, the cooking device 102 and the material transfer device 103. The communicative connection may be a wired communicative connection or a wireless communicative connection such as WIFI and Bluetooth.

With continued reference to FIG. 1, the automatic cooking apparatus 100 further includes a storage device 105 for storing at least one unit of unit material. The control device 104 may control material transfer device 103 to transfer unit material between the holding device 101 and the storage device 105. The storage device 105 may be configured to have more and larger storage spaces than the holding device 101 and may store the unit material for a longer period. For example, the storage device 105 may be configured as a structure similar to a freezer, refrigerator or freezer cabinet. The user may pre-store a large amount of material for multiple dishes in storage device 105. When a certain type of unit material is absent in the holding device 101, the control device 104 may control the material transfer device 103 to retrieve the unit material stored in the storage device 105 and replenish the holding device 101. The holding device 101 is located between the cooking device 102 and the storage device 105, and is closer to the cooking device 102 than the storage device 105, thereby shortening material transfer time during cooking processes and increasing efficiency.

In some embodiments, the storage device 105 also has a stock status detector (not shown) configured to detect at least one stock status parameter (temperature, humidity, air pressure, bacteria species, quantity of bacteria, sulfide concentration, material appearance, etc.) of at least one area of the storage device. In some embodiments, the storage device 105 also has a stock status controller that controls the at least one stock status parameter of the at least one area in the storage device within a predetermined range. The stock status detector and the settings, types and functions of the stock status controller are similar to the stock status detector and the stock status controller of the holding device, and thus are not described herein again.

Taking the stock status parameter being temperature as an example, the stock status detector of the storage device 105 includes a temperature sensor, and the corresponding stock status controller includes a temperature controller, i.e., a heating or cooling mechanism, to control the temperature of at least one area in the storage device 105. Due to different optimal storage temperatures for different materials. In some embodiments, the storage device 105 may be divided into a plurality of different temperature regions for effectively preserving different unit materials, maximizing their duration, and ensuring material safety and freshness. Specifically, in some embodiments, the storage device 105 is specifically divided into a vegetable storage area of 5 degree C. to 10 degree C., a meat storage area of 0 degree C., a frozen meat storage area of minus 18 degree C., etc. to meet the storage requirements of different materials, and keep the material fresh and safe. The unit material in the storage device 105 may be manually filled by the user. Similarly, the description of the application in the holding device 101 described above in terms of timed thawing, unit material deterioration detection and the like is also applicable to the storage device 105.

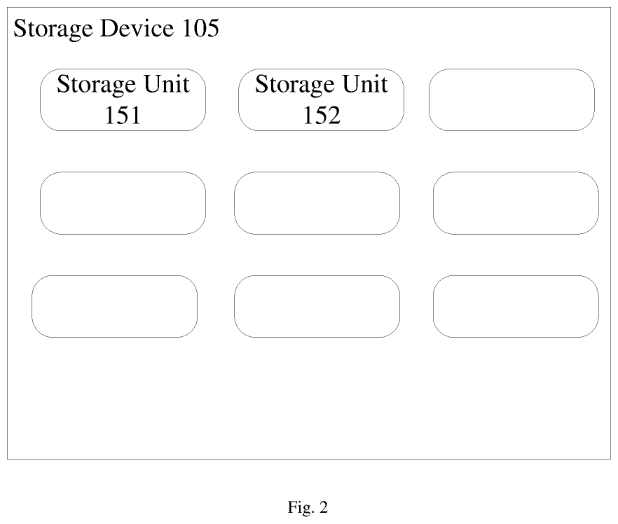

FIG. 2 shows a schematic diagram of an exemplary internal structure of a storage device 105 in the automatic cooking apparatus according to the present application, wherein the storage device 105 includes several storage units.

As shown in FIG. 2, the storage device 105 includes storage units 151 and 152, which may store unit materials with different material information. In the cooking process, the control device 104 acquires the material information of the unit material stored in the storage units 151 and 152, and controls the material transfer device 103 to transfer unit material between storage units 151, 152 and at least one holding device 101 according to the demand of the cooking program and the stocking level of the holding device. It will be understood that in some embodiments, the control device 104 may also control the material transfer device to acquire the unit material directly from various storage units of the storage device without staging through the holding device.

With continued reference to FIG. 2, in some embodiments, the storage units 151 or 152 respectively has a stock status detector for detecting at least one stock status parameter (temperature, humidity, air pressure, bacteria species, the quantity of bacteria, sulfide concentration, material appearance, etc.) within the storage units 151 or 152. In some embodiments, the storage units 151 or 152 also respectively has a stock status controller for controlling the at least one stock status parameter in the storage units within a predetermined range. The stock status detector and the stock status controller of the storage units are basically the same as the stock status detector and the stock status controller of the holding device 101 described above, thus the details are not described herein again.

Taking the stock status parameter being temperature as an example, the stock status detector includes a temperature sensor, and the stock status controller includes a temperature controller, i.e., a heating or cooling device, to control the temperature in the storage units 151 or 152. In some embodiments, the temperature controller, in conjunction with the temperature sensor, controls the temperature in the storage units 151 or 152 to the optimum storage temperature for the unit material stored therein based on the material information of the unit material, thereby maximizing the preservation duration, and ensuring the safety and freshness of the material. Specifically, in some embodiments, the unit material stored in the storage units 151 is frozen meat (e.g., frozen beef), so the temperature controller of the storage units 151 controls the temperature in the storage units 151 to minus 18 degree C. in conjunction with the temperature sensor. And the unit material stored in the storage units 152 is a vegetable (e.g., Chinese cabbage), the temperature controller in the storage units 152 controls the temperature in the storage units 152 to 5 degree C. in conjunction with the temperature sensor. Similarly, the description of the application of the temperature sensor and the temperature controller in the holding device 101 described above in terms of timed thawing, unit material deterioration detection and the like is also applicable to the storage units 151 and 152.

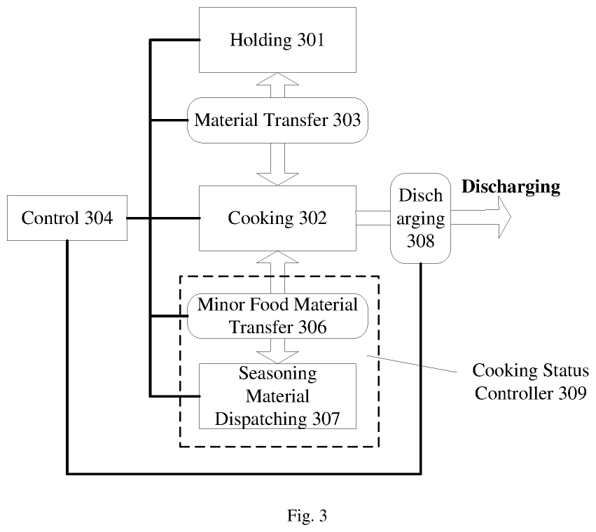

FIG. 3 shows a schematic view of an automatic cooking apparatus 300 according to another embodiment of the present application

As shown in FIG. 3, in some embodiments, a cooking device 302 also has a cooking status detector (not shown) for detecting at least one cooking condition parameter (salinity, acidity, temperature, air pressure, viscosity or moisture, etc.) of the dish or material being processed in the cooking device 302. In some embodiments, the cooking device 302 further includes a cooking status controller 309 configured to adjust at least one cooking condition parameter in cooking device 302, or control the at least one cooking condition parameter of at least one cooking device within the predetermined range. Specifically in some embodiments, the cooking status detector of the cooking device 302 includes a temperature sensor for detecting the temperature of the dish or material being processed in the cooking device. When the temperature is lower than the temperature required by the cooking program executed by the control device 304, the control device 304 controls the heating device of cooking device 302 to heat it so that its temperature reaches the set range. In some embodiments, the cooking status detector includes an air pressure sensor for detecting the air pressure of the inner cavity of the cooking device when processing the dish or material. The cooking device 302 also has a cooking status controller, which includes a steam generator. When the cooking device 302 executes a specific cooking program such as cooking stewed fish, since the cooking program requires a higher inner cavity air pressure such as 1.5 atm, when the air pressure detected by the air pressure sensor is lower than 1.5 atm, the steam generator starts to generate steam so that the air pressure in the cooking device 302 reaches the set range.

With continued reference to FIG. 3, in some embodiments the cooking status controller 309 includes a seasoning material dispatching device 307 and material transfer device 306 for minor food material. The seasoning material dispatching device 307 is used to store and dispatch the minor food material needed for cooking. The above minor food material includes, but are not limited to, condiments (such as soy sauce, cooking wine, salt, sugar, pepper, etc.) required for cooking, minor ingredients (such as scallion, ginger, garlic, chili, etc.) required for cooking, and accompanying materials (water, cooking oil, etc.) required for cooking, as well as some pre-made special food materials for cooking some dishes (e.g., pre-cooked broth, pre-mixed grill ingredients, etc.). The minor food material transfer device 306 transfers the minor food material in the seasoning material dispatching device 307 to the cooking device 302. In some embodiments, the seasoning material dispatching device 307 further includes a minor food material dispatching control device (not shown) for controlling the quantity and/or the rate of the minor food material to be released from the seasoning material dispatching device 307. In some embodiments, the minor food material dispatching control device is a metering valve or a solid flow control valve. In some embodiments, the seasoning material dispatching device 307 is communicatively coupled to the control device 304, and delivers the minor food material stored in the seasoning material dispatching device 307 into one or more storage cups according to the quantity or weight indicated by the cooking program executed by the control device 104. In some embodiments, the minor food material transfer device 306 is communicatively coupled with the control device 304. The control device 304 controls the minor food material transfer device 306 to transfer the minor food materials, which have been downloaded into the one or more storage cups by the seasoning material dispatching device 307, to the holding device 301 connected to the cooking device 302, and then transfer the minor food material from the holding device 301 into the cooking device 302 according to the cooking program being executed. Alternatively, the minor food material downloaded into the one or more storage cups in the seasoning material dispatching device 307 may be directly transferred to the cooking device 302, following certain sequence and timing according to the cooking program being executed.

In some embodiments, the cooking status sensor includes an artificial sweetness sensor, a salinity sensor, a pH sensor, a moisture sensor, and the like. The sensor is communicatively connected to the control device 304. The control device 304 controls the minor food material transfer device 306 to transfer the minor food material of the seasoning material dispatching device 307, corresponding to the at least one cooking parameter, to the cooking device according to the at least one cooking condition parameter in conjunction with the cooking program executed by the control device 304. Taking the cooking condition parameter being sweetness as an example, the control device 304 compares the sweetness detected by the cooking status sensor with a predetermined sweetness in the cooking program being executed, and when the detected sweetness is lower than the predetermined sweetness, controls the minor food material transfer device 306 to transfer certain quantity of sugar or similar flavor from the seasoning material dispatching device 307 to the cooking device 302 so as to increase the sweetness of the dish or material. Note that the correspondence between the condiment and the cooking condition parameter is not necessarily one-to-one correspondence. For example, in some embodiments, if the salinity is too high, the corresponding condiments may be vinegar, sugar, water, etc. The control device 304 may control the minor food material transfer device 306 to transfer minor food material such as vinegar, sugar or water to the cooking device 302 to adjust the salinity of the dish being processed in the cooking device.

In some embodiments, the seasoning material dispatching device 307 has a screw that can deliver powdered minor food material with a specified quantity or weight into one or more storage cups. In some other embodiments, the seasoning material dispatching device 307 has a knob with a fixed volume that is able to deliver granular minor food material with a specified quantity or weight into one or more storage cups. In some other embodiments, the seasoning material dispatching device 307 has a delivery pipe and a pump that may deliver liquid minor food material with a specified quantity or weight into one or more storage cups. The minor food material transfer device 306 has a robotic arm and gripper to capture the storage cups delivered by the seasoning material dispatching device 307 and pour the minor food material into the cooking device 302. In some embodiments, the minor food material transfer device 306 also has a spring stripe to flick a small quantity of the minor food material from the seasoning material dispatching device into the cooking device 302.

In some embodiments, minor food material transfer device 306 includes a delivery pipe and a pump to deliver liquid minor food material, such as water, soy sauce, etc. In some specific embodiments, the minor food material transfer device 306 also has an electromagnetic valve for adjusting the quantity and transfer speed of the liquid minor food material being delivered.

In some embodiments, the automatic cooking apparatus 300 further includes multiple seasoning material dispatching devices, wherein each seasoning material dispatching device stores a type of minor food material correspondingly. In some specific embodiments, the control device 304 may number each seasoning material dispatching device, and then to determine the type of minor food material stored therein based on that number later on. For example, in one embodiment, the seasoning material dispatching device No. 1 stores salt, the seasoning material dispatching device No. 2 stores sugar, the seasoning material dispatching device No. 3 stores soy sauce, and so on. In another embodiment, each of the above seasoning material dispatching devices may have an identifiable mark that matches the information of the minor food material stored therein. In some embodiments, the control device 304 scans the mark of each seasoning material dispatching device to determine the minor food material stored therein. The above identifiable mark may be a radio frequency tag or a bar code.

With continued reference to FIG. 3, in some embodiments, the cooking apparatus 300 further includes a discharging device 308 for discharging the unit material or dish processed in the cooking device 302. In some embodiments, the discharging device 308 includes a fetching device, or driving device for the cooking device 302. The fetching device may be a device for scooping, grasping, pushing, pulling, scraping and the like, thereby taking out the processed dish from the inner cavity of the cooking device 302. The driving device for cooking device 302 may be a device such as a pan turning device, a dumping mechanism, or the like, that controls the inner cavity of the cooking device 302 to move so that the dish in the cooking device 302 is poured out. Note that the above discharging device 308 may replace the material transfer device 303 for discharging the intermediate material in the cooking process, for example, by transferring the processed material in the cooking device 302 to the holding device 301.

In some embodiments, the unit material described above refers to food materials in unit quantity or unit weight. For example, 100 g, 200 g or 500 g of pork, chicken or Tofu, etc., as shown in Table 3 below. In addition to the type and the quantity or weight of the material, in some embodiments, the unit material may further be classified according to the different parts (e.g., of a beef), different quality grades, and different shapes. As shown in Table 3 below, the unit material may include grade 1 shredded pork from hind buttocks, grade 2 pork chunks from streaky pork, and shredded radish from radish rhizomes. In some embodiments, the unit material may also be classified according to their pretreatment process, like, marinated fish fillets, starched shredded pork and so on.

Therefore, the material information of the unit material includes food species, quantity, weight, date of cutting, pretreatment method, etc. Through a standardized classification scheme for the unit materials and their corresponding material information we can achieve the normalization and standardization of the entire cooking process. As shown in Table 3 below, the material information of the unit material includes but is not limited to the food category, food species name, part within body, quality grade, shape, size, unit weight, etc. In some embodiments, the control device 104 quickly and accurately selects the materials for cooking that match the specific requirements in parameters like food category, quality, shape, size or quantity, and weight of the material, either from a cooking program or from the customized cooking instruction of the user. In some embodiments, the control device 104 choose to use the materials according to the order of their cutting date and shelf-lives, to ensure the freshness and safety of the material to be cooked.

In some embodiments, the material information of the unit material further includes pretreatment of the material, for example, starched fish fillets, marinated chicken wings and the like. The control device 104 may directly select the corresponding pre-processed unit material according to the material information, thereby greatly improving the cooking speed and efficiency. In some embodiments, the pre-processed unit material may be unit material that has been pre-processed before being loaded into the automatic cooking apparatus. For example, the unit material may be pre-processed manually (using containers or other processing equipment) or pre-processed separately by other processing machines or equipment. In other embodiments, the automatic cooking apparatus 100 may further have a pretreatment device (not shown). The pretreatment device may be a marinating device, a pre-heating device, etc. The control device 104 controls the above pretreatment devices to pre-process the unit material and records the pretreatment method of the material in the material information of the unit material.

TABLE 3
Material specification parameter list

| | | Part | | | | | Days |
|---|---|---|---|---|---|---|---|
| | | with | | | Size | Weight | after |
| Category | Name | Body | Grade | Shape | (mm) | (g) | cutting |
| Pork | Pork | Streaky | 1 | Chunk | | 100 | |
| | Ham | pork | 2 | Slice | | 200 | |
| | | Rear | 3 | Diced | | 500 | |
| | | buttocks | | Shredded | | 1000 | |
| | | | | Minced | | | |
| Beef/ | Beef | | | | | | |
| Mutton | | | | | | | |
| Poultry | Chick- | | | | | | |
| | en | | | | | | |
| Seafood | sole | | | | | | |
| | fish | | | | | | |
| Eggs | Egg | | | | | | |
| Bean | Tofu | | | | | | |
| products | | | | | | | |
| Vegetable | Radish | Leaf | | Strip | | | |
| | | Rhi- | | Chunk | | | |
| | | zome | | Shredded | | | |

In some embodiments, the unit material has an identifiable mark that matches the corresponding material information of the unit materials. In some embodiments, the identifiable mark is attached to the external packaging or container of the unit material. In some embodiments, however, the identifiable mark is attached to the storage units 151.

In some embodiments, the identifiable mark is one-dimensional or two-dimensional barcode that matches the material information of the unit material. In a specific embodiment, as shown in Table 3 above, the unit material is a grade 1 shredded pork from rear buttocks with a size of 10 mm and a weight of 200 g and the cutting date is March 9. The content of the one-dimensional or two-dimensional barcode corresponding to the material information of the unit material is a number string such as “0011212010020309”. The first three digits of the number string “001” represent that the category of the material is “meat”; the fourth digit “1” represents the name of the material is “pork”; the fifth digit “2” represents the part with body of unit material is “rear buttocks”; the sixth digit “1” represents the material grade is “grade 1”; the seventh digit “2” represents the shape of the material is “shredded”; the eighth to tenth digits “010” represent the size of pork unit material is 10 mm; the eleventh to twelfth digits “02” represent the quantity and weight of the unit material is “200 g”; and the last four digits “0309” represent the cutting date of the unit material is March 9.

It should be noted that, although in the above embodiment, the unit material information is represented by a number string with fixed number of digits, the material information may of course adopt a number string with other number of digits, a letter string and all other symbols with similar functions. In other embodiments, the identifiable mark is a radio frequency label.

In some embodiments, the automatic cooking apparatus further includes a material detector for detecting the material information corresponding to the unit material. Specifically in some embodiments, the material detector is located at a holding device, a storage device, or a storage units for detecting the unit material stored at the above device or unit, and generating corresponding material information. In some embodiments, the material detector is a radio frequency label scanner or bar code scanner that scans identification information provided in the external packaging of the unit material. In some other embodiments, the material detector of the automatic cooking apparatus includes a near-infrared scanner that verifies the category of unit material by scanning the unit material to obtain its near-infrared spectrum and comparing it with a database of known material spectrums. In some embodiments, the material detector further includes a weight sensor for detecting the quantity and weight of the unit material. In still other embodiments, the material detector further includes a camera and a computer image recognition system for obtaining the category, name, body section, shape or other information of the unit material.

As described above, in some embodiments, the storage device 105 or storage units 151 or 152 is provided with a material detector for detecting the material information of the stored unit material. The control device 104 may count the unit material according to the detected material information, and access the aforementioned menu database to search and acquire one or more cooking programs that match the amount and types the available unit materials. In some specific embodiments, the control device 104 detects that the unit materials stored in the storage device 105 only have three tomatoes and two eggs, and retrieves cooking programs in the menu database specifically for that types and quantities. The retrieved cooking programs, which match the above observed types and quantities, include 1 unit of tomato scrambled egg (two tomatoes and two eggs per unit for the cooking program) and two tomato egg soups (one tomato and one egg per unit for the cooking program). Thus a new menu that includes one unit of tomato scrambled egg and two units of tomato egg soup is obtained.

In some embodiments, the automatic cooking apparatus further includes an input device (not shown) communicatively connected to the control device 104 and configured to receive unit material information stored in at least one holding device inputted to it. It will be understood that in some embodiments, the user may also input material information of unit material stored in the storage device or storage units via the input device. In some embodiments, the above input device is voice-based and may translate the user's natural language into information that the control device 104 may process.

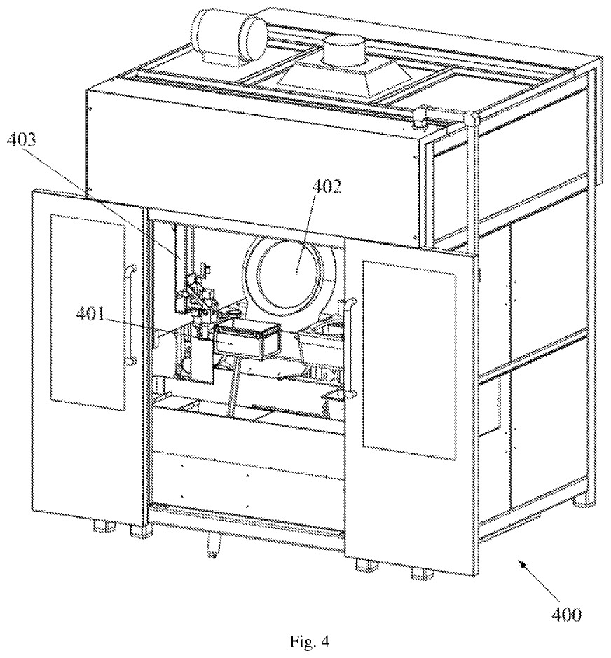

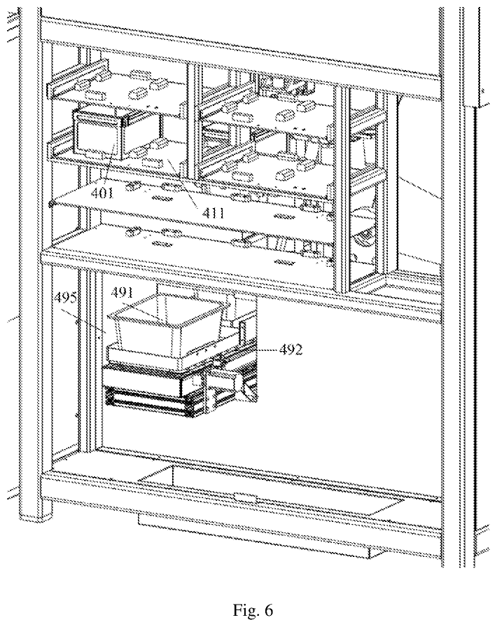

FIGS. 4 to 7 show an automatic cooking apparatus 400 according to one embodiment of the present application. As shown in FIG. 4 and FIG. 6, the automatic cooking apparatus 400 further has a rack 411 for placing at least one holding device 401. During cooking, the material transfer device 403 grips a holding device 401 from the rack 411 and moves it to the opening of the inner cavity of the cooking device 402 so that the unit material stored in the holding device 401 is poured into the cooking device 402.

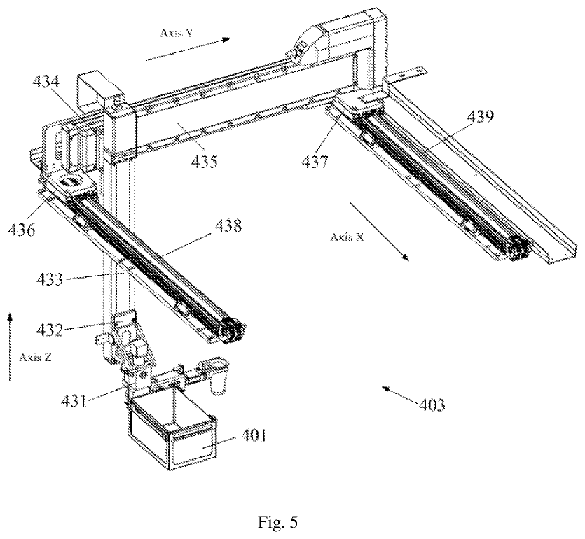

FIG. 5 shows a perspective view of the material transfer device 403 of the automatic cooking apparatus 400 of FIG. 4. As shown in FIG. 5, the material transfer device 403 has a gripping device 431 for gripping the holding device 401, the gripping device 431 is placed on a Z-axis moving slider 432 and may move along with the Z-axis moving slider. The gripping device 431 may also rotate around its own central axis or an axis parallel to the central axis so that the unit material in the holding device 401 may be poured into the opening of the cooking device 402. The Z-axis moving slider 432 is placed on the Z-axis guide rail 433 and is movable along the Z-axis guide rail 433. One end of the Z-axis guide rail 433 is placed on a Y-axis moving slider 434 and is movable along with the Y-axis moving slider 434. The Y-axis moving slider 434 is placed on a Y-axis guide rail 435 and is movable along the Y-axis guide rail 435. Two ends of the Y-axis guide rail 435 are placed on X-axis sliders 436 and 437, respectively, and are movable along X-axis guide rails 438 and 439 along with the X-axis sliders 436 and 437. With this material transfer device 403, unit material in the holding device 401 at any position on the rack 411 may be transferred to the cooking device 402.

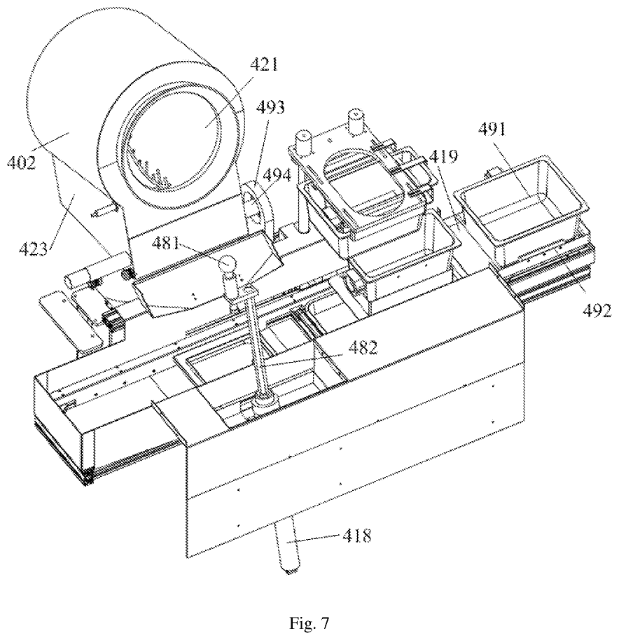

As shown in FIG. 7, the cooking device 402 of the automatic cooking apparatus 400 is cylindrical, and includes a cylindrical inner cavity 421. A heating belt 422 (not shown) is evenly placed on the sidewall of the inner cavity 421. The automatic cooking apparatus 400 further includes a supporting base 423 for supporting the cooking device 402. The cooking device 402 is placed on the supporting base 423, and a round bottom of the cooking device 402 is placed on a rotating shaft 424 (not shown) which is connected to the supporting base 423, allowing the cooking device 402 to rotate with the rotating shaft 424.

With continued reference to FIG. 7, the automatic cooking apparatus 400 further includes a discharging device 419. The discharging device 419 includes a dish container 491 for accommodating dishes, a transfer device 492 and a discharging rack 493. The dish container 491 is placed on the transfer device 492 and can be linearly moved along the guide rail with the transfer device 492. The cooking device 402 is coupled to the discharging rack 493 and is rotatable about a rotating shaft 494 of the discharging rack 493 so that the opening of the cooking device may approach or depart from the transfer device 492. In an actual discharging process of a particular embodiment, the transfer device 492 transfers the dish container 491 to be near the cooking device 402 and then the cooking device 402 rotates about the rotating shaft 494 of the discharging rack to dump the dish in the inner cavity of the cooking device 402 into the dish container 491. In some embodiments, as shown in FIG. 6, the dish container 491 of the automatic cooking apparatus 400 is transferred out of the automatic cooking apparatus 400 by the transfer device 492 through the discharging port 495, thereby completing the entire cooking process.

In some embodiments, the automatic cooking apparatus 400 further has a cleaning device for cleaning the holding device, the cooking device, the material transfer device, the seasoning material dispatching device, the minor food material transfer device. In some embodiments, the cleaning device is a clean in place (“CIP”) cleaning device that intensively cleans components such as the holding device, the cooking device, the material transfer device, the seasoning material dispatching device, the minor food material transfer device and the like with a high-temperature and high-concentration cleaning solution, without disassembling or moving the automatic cooking apparatus. In some embodiments, the cleaning device has a plurality of cleaning programs. Different cleaning programs are executed for different cooking programs or for different components to be cleaned. With continued reference to FIG. 7, the automatic cooking apparatus 400 further includes a cleaning device 418. The cleaning device 418 includes a spherical nozzle 481 and a supporting rod 482. The supporting rod 482 is horizontally and vertically movable relative to the automatic cooking apparatus 400 or adjust its tilt direction and/or tilt angle relative to the automatic cooking apparatus 400. The spherical nozzle 481 is placed at an upper end of the supporting rod 482 and is able to switch the spraying position and angle according to the movement of the supporting rod 482 so as to clean different shaped devices, different positions of a certain device and all blind corners.

In some embodiments, the automatic cooking apparatus further includes a waste collecting device. The waste collecting device collects waste, such as waste water, waste oil, or waste residues produced during cooking and washing, into a designated container, such as an oil-water separator.

In some embodiments, the automatic cooking apparatus further has a sterilizing device for sterilizing the automatic cooking apparatus. In some embodiments, the sterilizing device is an ultraviolet sterilizing device. In other embodiments, the sterilizing device is a steam sterilizing device.

In some embodiments, the automatic cooking apparatus also has a safety interlock device. In some embodiments, the safety interlock device includes a temperature sensor, a pressure sensor, and a smoke sensor. The safety interlock device causes the automatic cooking apparatus to have an emergency stop when the reading of the temperature sensor, the pressure sensor or the smoke sensor exceeds a preset value. In some embodiments, the safety interlock device further includes monitoring and protection of safe movement ranges of the moving devices such as the material transfer device, discharging device and the transfer device. When the position sensor detects that the corresponding device is about to move beyond a preset safety value, the control device will perform a series of actions such as stopping the movements and alerting the user.

In some embodiments, the automatic cooking apparatus further includes a man-machine interaction interface communicatively connected to the control device of the automatic cooking apparatus. A user may input material information of the unit material, read real-time menus, select cooking programs, adjust cooking parameters. In some embodiments, the above man-machine interaction may also be remote implemented with wireless communication, for example through a remote control interface such as an APP of a smart phone which gives a cooking instruction and the like. In some embodiments, the above man-machine interface may be voice-based, including voice prompts and voice confirmations. The above voice service may also be based on artificial intelligence, which may communicate with users intelligently based on user's habits. In some embodiments, the above man-machine interface may be based on VR (Virtual Reality), AR (Augmented Reality), or MR (Mixed Reality).

In some embodiments, the menu database of the above-mentioned automatic cooking apparatus further has a personalization module that may record dish preferences of a certain customer and taste preferences for one or more dishes which would be helpful for a cooking device user to customize dish for the customer. The above-mentioned automatic cooking apparatus may also recommend a corresponding menu based on a list of dishes the user has previously cooked using the automatic cooking apparatus, and the user's history of ordering preferences. In some embodiments, the automatic cooking apparatus may also be connected to the Internet to update menus through a cloud server, and feedback operating parameters of the automatic cooking apparatus for fault prevention and trouble-shooting.

In some embodiments, the menu database of the automatic cooking apparatus further includes a log module for automatically recording log information such as execution parameters at different moments of the cooking process. In some embodiments, the man-machine interface of the above automatic cooking apparatus includes an interface for a dish developer. The dish developer may manually operate each cooking unit in real time and change the operating parameters of the cooking unit in real time. The log module may record and restore such series of operations, to facilitate the dish developers to develop dishes. In some embodiments, the log module may also analyze log information and provide related data services including, but not limited to, audits of operations, analysis of nutritional trends, analysis of seasonally varied menus, statistical analysis of preferred tastes of different regions, tracking of the treatment effect of a traditional Chinese medicine session. In some embodiments, the menu database may also include general nutritional information and user-specific nutritional information, such as calories and protein intake. For those who participate in specific nutritional programs, there are nutritional menus from specific nutritional designs.

In some embodiments, the above-mentioned automatic cooking apparatus has a battery system for providing the power required for the operations of the cooking appliance and can be charged at the user's current kitchen power capacity. This way the cooking apparatus won't be limited by the power capacity of the user's kitchen when that power capacity is lower than the rated power of the cooking apparatus.

In some embodiments, the above described automatic cooking apparatus may be mounted on a mobile vehicle, for mobile food service and saving kitchen space. The cooking operations may be carried out simultaneously when the vehicle is on the road, thus saving service time. The vehicle-mounted cooking apparatuses may be powered by batteries or gasoline/diesel based generators.

In some embodiments, the above-mentioned automatic cooking apparatus may be used in a self-operated restaurant (including chain restaurants, corporate canteens, etc.), and all dishes are provided through the automatic cooking apparatus. The menu may either be provided by the restaurant operator, or be selected by the restaurant customer, from a cloud database, based on the restaurant's currently available food stock.

In some embodiments, the above-mentioned automatic cooking apparatus can also be used at home, which could help user to realize remote cooking control. Similarly, the automatic cooking apparatus can also be used for remote chef service. Personalized dish may be produced by an automatic cooking apparatus with the help of a life chef operating the apparatus from afar and making parameter adjustment. In some embodiments, the above-mentioned automatic cooking apparatus can also serve as a self-service vending machine placed in a hotel, an office building or a school dorm, to provide dishes freshly made on-site. In some embodiments, multiple automatic cooking apparatuses may also form a public kitchen, and users may rent time slots of the automatic cooking apparatus to cook food material they brought from home or purchased from a public kitchen or a nearby convenient store. The cooking appliances in this public kitchen may be operated by staff or by the users themselves.

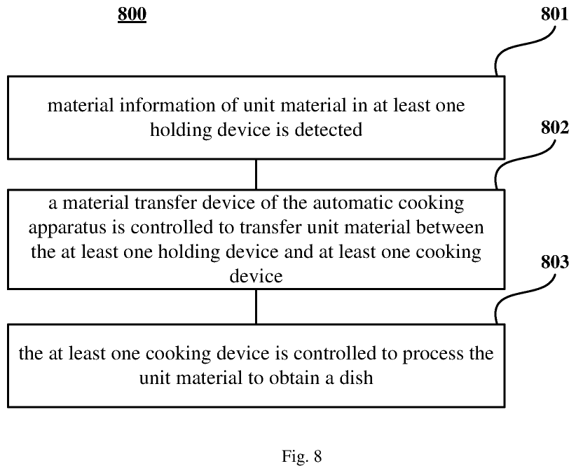

FIG. 8 shows a flowchart of a cooking method 800 using an automatic cooking apparatus according to one embodiment of the present application. According to FIG. 8, the cooking method shown comprises the following steps:

In step 801, material information of unit material in at least one holding device is detected. In some embodiments, as described above, the unit material in the holding device may be scanned by the material detector of the automatic cooking apparatus to obtain the material information of the unit material. In step 802, a material transfer device of the automatic cooking apparatus is controlled to transfer unit material between the at least one holding device and at least one cooking device. In step 803, the at least one cooking device is controlled to process the unit material to obtain a dish.

In a specific embodiment, boiled bean curd shreds with thick chicken broth may be produced using the automatic cooking apparatus described above, wherein a first holding device stores a unit quantity of fresh chicken and the second holding device stores a unit quantity of bean curd shreds. First, the material information of the unit quantity of fresh chicken and the unit quantity of bean curd in the holding device is acquired. Then, the unit quantity of fresh chicken with water and other minor food material in the first holding device is transferred to a first cooking device, and then the first cooking device is controlled to process the unit material put therein to obtain thick chicken soup and cooked chicken. After that, the thick chicken soup is transferred from the first cooking device to the first holding device, and the cooked chicken is transferred to a third holding device. The bean curd shreds from the second holding device is then heated in a second cooking device, together with the thick chicken soup from the first holding device, for 15 to 20 minutes to arrive at the final dish.

In some embodiments, the automatic cooking apparatus utilized by the above method comprises a first cooking device and a second cooking device, the method further comprising the following steps: controlling the material transfer device to transfer unit material between the first cooking device and the second cooking device. Taking the above-mentioned boiled bean curd shreds with chicken soup as an example. After the first cooking device cooks and obtains the thick chicken soup and the cooked chicken, the thick chicken soup in the first cooking device may be directly transferred to the second cooking device, and then the bean curd shreds in the second holding device is transferred to the second cooking device and then heated for 15 to 20 minutes therein to finally obtain the dish.

In some embodiments, the above method further includes a step 804 (not shown). In the step 804, a cooking program for cooking a final dish is obtained, steps 802 and 803 are performed according to the acquired at least one cooking program, and the material transfer device is controlled to transfer the unit material between the at least one cooking device and at least one cooking device; controlling at least one cooking device to process the unit material and then obtaining dish. In some embodiments, the step 804 is performed before the step 801. The cooking program is determined firstly, and then the material information of the unit material stored in the holding device is obtained. In some other embodiments, the step 804 is performed after the step 801, and the cooking program is obtained based on the material information of the unit material stored in the given holding device.

It should be noted that although several modules or sub-modules of the automatic cooking device are mentioned in the detailed description above, such division is merely exemplary and not mandatory. In fact, according to the embodiments of the present application, the features and functions of the two or more modules described above can be embodied in one module. Conversely, the features and functionality of one module described above can be further divided into multiple modules.

Those of ordinary skill in the art may, upon studying the specification, the disclosure, the drawings, and the appended claims, understand and practice other changes to the disclosed embodiments. In the claims, the words “comprising”, “comprise”, “including”, and “include” do not exclude other elements and steps, and the expressions “a” and “one” do not exclude the plural. In the practical application of the present application, a part may perform the function of the plurality of technical features cited in the claims. Any reference signs in the claims should not be construed as limiting the scope.

1. An automatic cooking apparatus, comprising:
at least one holding device configured to receive and store unit material, wherein the unit material has corresponding material information;
at least one cooking device configured to receive and process the unit material from the at least one holding device;
a material transfer device configured to transfer the unit material between the at least one holding device and the at least one cooking device; and
a control device configured to acquire the material information of the unit material stored in the at least one holding device to control the material transfer device to transfer the unit material between the at least one holding device and the at least one cooking device, and control the at least one cooking device to process the received unit material.

2. The automatic cooking apparatus according to claim 1, wherein the control device is further configured to acquire a cooking program and execute the acquired cooking program to control the material transfer device to transfer the unit material between the at least one holding device and the at least one cooking device, and control the at least one cooking device to process the received unit material to obtain a dish.

3. The automatic cooking apparatus according to claim 2, wherein the cooking program specifies at least one of the following parameters: type of desired unit material, quantity or weight of desired unit material, desired cooking process, and cooking conditions.

4. (canceled)

5. The automatic cooking apparatus according to claim 2, wherein the control device acquires the cooking program based on the acquired material information of the unit material stored in the at least one holding device.

6. The automatic cooking apparatus according to claim 1, further comprising:
a storage device configured to store at least one unit of unit material;
wherein the control device is further configured to control the material transfer device to transfer the unit material between the storage device and the at least one holding device.

7. The automatic cooking apparatus according to claim 6, wherein the at least one holding device is closer to the at least one cooking device than the storage device.

8. The automatic cooking apparatus according to claim 6, wherein the storage device comprises a stock status detector configured to detect at least one stock status parameter of at least one area of the storage device.

9. The automatic cooking apparatus according to claim 8, wherein the storage device further comprises a stock status controller configured to control the at least one stock status parameter of the at least one area of the storage device within a predetermined range, according to the detection result of the stock status detector.

10. The automatic cooking apparatus according to claim 6, wherein the control device is further configured to obtain statistics of the material information of the at least one unit material stored in the storage device, and acquire the cooking program according to the statistics of the material information.

11. The automatic cooking apparatus according to claim 6, wherein the storage device comprises:
at least one storage unit configured to store at least one unit of unit material;
wherein the control device is configured to acquire the material information of the unit material stored in the at least one storage units to control the material transfer device to transfer the unit material between the at least one storage units and the at least one holding device.

12. The automatic cooking apparatus according to claim 11, wherein the at least one storage units has a material detector for detecting the at least one unit of unit material stored therein and generating corresponding material information.

13. (canceled)

14. (canceled)

15. (canceled)

16. (canceled)

17. The automatic cooking apparatus according to claim 1, wherein the at least one holding device has a stock status detector configured to detect at least one stock status parameter in the holding device.

18. The automatic cooking apparatus according to claim 17, wherein the holding device further comprises a stock status controller configured to control the at least one stock status parameter in the holding device within a predetermined range.

19. The automatic cooking apparatus according to claim 8, wherein the stock status parameter comprises at least one of the following parameters: temperature, humidity, air pressure, bacteria species, the quantity of bacteria, concentration of sulfides, and appearance of material.

20. The automatic cooking apparatus according to claim 1, wherein the material information includes at least one of the following information: unit material type, quantity, weight, date of preparation, pretreatment method.

21. The automatic cooking apparatus according to claim 1, wherein the unit material has an identifiable mark that matches the material information corresponding to the unit material.

22. (canceled)

23. The automatic cooking apparatus according to claim 1, further comprising a cooking status detector configured to detect at least one cooking condition parameter of the unit material being processed in the at least one cooking device.

24. The automatic cooking apparatus according to claim 1, further comprising a cooking status controller configured to control at least one cooking condition parameter in the at least one cooking device within a predetermined range.

25. The automatic cooking apparatus according to claim 23, wherein the at least one cooking condition parameter comprises at least one of the following parameters: sweetness, salinity, acidity, air pressure, temperature, viscosity, and moisture.

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. A method for cooking with an automatic cooking apparatus comprising:
detecting material information of unit material in at least one holding device;
controlling a material transfer device to transfer the unit material between the at least one holding device and at least one cooking device; and
controlling the at least one cooking device to process the received unit material.

42. (canceled)

43. (canceled)
